(19) United States
(12) Patent Application Publication
(10) Pub. No.: US 2015/0101050 A1
(43) Pub. Date: Apr. 9, 2015

(54) DETECTING AND MEASURING MALWARE THREATS

(71) Applicant: Bank of America Corporation, Charlotte, NC (US)

(72) Inventors: Brett Nielson, Newbury Park, CA (US); Sounil Yu, Reston, VA (US)

(73) Assignee: Bank of America Corporation, Charlotte, NC (US)

(21) Appl. No.: 14/047,745

(22) Filed: Oct. 7, 2013

(51) Int. Cl. G06F 21/56

(52) U.S. Cl. CPC G06F 21/56
USPC 726/23

(57) ABSTRACT

Methods, systems, computer-readable media, and apparatuses for detecting and measuring malware threats are presented. In some embodiments, a computing device may collect malware detection data from one or more monitored applications. Subsequently, the computing device may aggregate the collected malware detection data. Then, the computing device may generate a heat map based on the aggregation of the collected malware detection data, where the heat map is configured to identify one or more malware threats associated with one or more monitored applications. In some arrangements, collecting the malware detection data may include monitoring various aspects of a client computing device and/or the client computing device's communications with one or more servers and/or other devices that may be configured to provide the one or more monitored applications.

### BACKGROUND

Aspects of the disclosure relate to computer hardware and software. In particular, one or more aspects of the disclosure generally relate to computer hardware and software for detecting and measuring malware threats, including malware infections, malware attacks, and/or other kinds of threats associated with malware.

Large organizations, such as financial institutions, may face different kinds of information security threats and computer-based attacks from different sources. For example, in addition to confronting denial-of-service attacks that may be launched from various computer systems and networks around the world, a large organization and its computer systems may be exposed to malware-based attacks from end-user devices that are owned and/or operated by legitimate users, such as the organization's own customers. In particular, malware running on such end-user devices may be configured to attack the organization's systems, servers, and applications without the device user's knowledge or involvement.

As customers increasingly demand, and businesses increasingly provide, various services via electronic channels, such as specialized websites and mobile applications, ensuring information security while detecting and responding to attacks on and/or other threats facing organizational computer systems and/or other computing resources becomes increasingly important. For organizations that offer many different kinds of products and/or provide many different externally-facing applications to customers, however, it can be difficult to gain a perspective on what kinds of attacks and/or other threats the organization may be exposed to across different systems, servers, and/or applications, which may then make it difficult for the organization to appropriately respond to such attacks and/or threats.

### SUMMARY

Aspects of the disclosure provide effective, efficient, and convenient ways of detecting and measuring malware threats, including malware infections, malware attacks, and/or other kinds of threats associated with malware.

In particular, some aspects of the disclosure provide ways of detecting malware on end-user devices that may be affecting externally-facing applications (e.g., by interrogating end-user devices and/or applications running on such devices, such as web browsers that may be exchanging data with and/or otherwise interacting with an organization's externally-facing applications and/or computer systems) and/or otherwise recognizing malware threats that may be affecting one or more monitored applications (e.g., by looking for patterns and/or signatures in data packets and/or other information that may be exchanged with malware-infected devices while they are interacting with and/or otherwise accessing one or more monitored applications). In addition, some aspects of the disclosure provide ways of aggregating, presenting, and/or analyzing the collected malware information so that it can be used by an organization and/or by individuals within the organization in deciding how to appropriately respond to particular malware threats.

By gaining a better understanding of what malware threats exist, what types of malware may be attacking, where various attacks originate, and/or what impact such attacks may be having, an organization may be able to better respond to such threats. For instance, in responding to one or more malware threats, the organization may increase security defenses and/or controls associated with affected applications and/or computer systems; track infected client computing devices and prevent them from connecting to the organizations systems, servers, and/or applications; notify affected end users that their computing devices are infected with particular malware; and/or alert and/or request assistance from external entities, such as law enforcement and/or other government agencies, about particular malware threats.

Thus, in some embodiments discussed below, a computing device may collect malware detection data from one or more monitored applications. Subsequently, the computing device may aggregate the collected malware detection data. Then, the computing device may generate a heat map based on the aggregation of the collected malware detection data, where the heat map is configured to identify one or more malware threats associated with one or more monitored applications.

In some arrangements, collecting the malware detection data may include monitoring various aspects of a client computing device and/or the client computing device's communications with one or more servers and/or other devices that may be configured to provide the one or more monitored applications. For example, in collecting the malware detection data, the computing device may monitor one or more mouse clicks and/or keystrokes (which may, e.g., be representative of malware on the client computing device interacting with the one or more monitored applications), the network address (e.g., IP address) of the client computing device and/or other device fingerprint information, such as MAC address, serial number, and/or other unique hardware and/or software identifiers (which may, e.g., enable the computing device to track which of the one or more monitored applications the client computing device is interacting with and/or attempting to interact with), and/or failed log-in information (which may, e.g., enable the computing device to establish a risk score indicative of whether the client computing device is being legitimately used to access one or more user accounts associated with the one or more monitored applications and/or whether the client computing device is being maliciously used to access such account(s) without authorization).

In other arrangements, generating the heat map may include measuring malware variant (e.g., the type and/or version of the malware that is infecting the client computing device and/or attacking the one or more monitored applications), malware severity (e.g., the impact that the malware and/or particular types of malware are having on the one or more monitored applications and/or organizational resources, such as servers and/or other systems that may be configured to provide the one or more monitored applications), and/or malware volume (e.g., the amount of data that the malware and/or the infected client computing device(s) are exchanging with the one or more monitored applications and/or other organizational resources, such as servers and/or other systems that may be configured to provide the one or more monitored applications).

In some arrangements, generating the heat map may include performing a trend analysis based on the aggregation of the collected malware data, and the heat map may be generated based on the trend analysis. For example, in generating the heat map, the computing device may identify one or more trends in the malware detection data, such as trends in the types of malware detected on client computing device(s) and/or attacking the one or more monitored applications, trends in the frequency of malware attacks (e.g., with respect to particular type(s) of malware and/or overall with respect to all types of malware), and/or other trends. In addition to identifying the one or more trends, the computing device may insert information associated with the identified trends into the heat map, as such trend information may represent predictive data about future conditions for the state(s) of the one or more monitored applications.

In some arrangements, the computing device may be further configured to cause at least one dynamic response to be provided based on the generated heat map. For example, in a particular browsing session in which a particular client computing device and/or a particular user thereof is interacting with a monitored application, the computing device may selectively increase or decrease an amount of friction encountered by the client computing device and/or the user during the browsing session based on information included in the heat map and/or based on the collected malware detection data. For instance, if the computing device detects that the client computing device is infected with a particular type of malware (e.g., based on device fingerprint information, based on interrogating the browser being used on the client computing device by the user, based on other information received from the client computing device, and/or the like), the computing device may increase friction during the browsing session by crippling the monitored application. In crippling the monitored application, the computing device may, for instance, selectively disable one or more functions that might otherwise be available (e.g., to other devices and/or users that are not infected with the malware and/or that otherwise have lower risk levels and/or risk scores).

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of a system for detecting and measuring malware threats according to one or more embodiments;

FIG. 3 illustrates a flowchart that depicts a method of detecting and measuring malware threats according to one or more embodiments;

FIG. 4 illustrates an example of a user interface that may be displayed in providing status information about malware threats in one or more embodiments; and

FIG. 5 illustrates another example of a user interface that may be displayed in providing status information about malware threats in one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

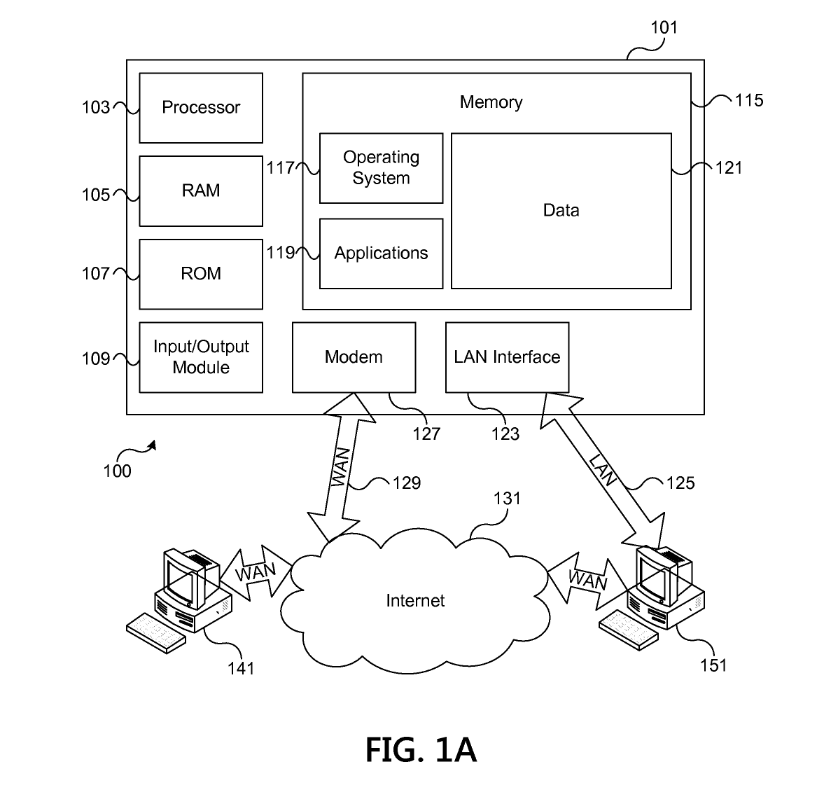

As noted above, certain embodiments are discussed herein that relate to detecting and measuring malware threats. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perforin various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail. As introduced above, some aspects of the disclosure generally relate to detecting and measuring malware threats. In the discussion below, various examples illustrating how malware threats may be detected and/or measured in accordance with one or more embodiments will be provided.

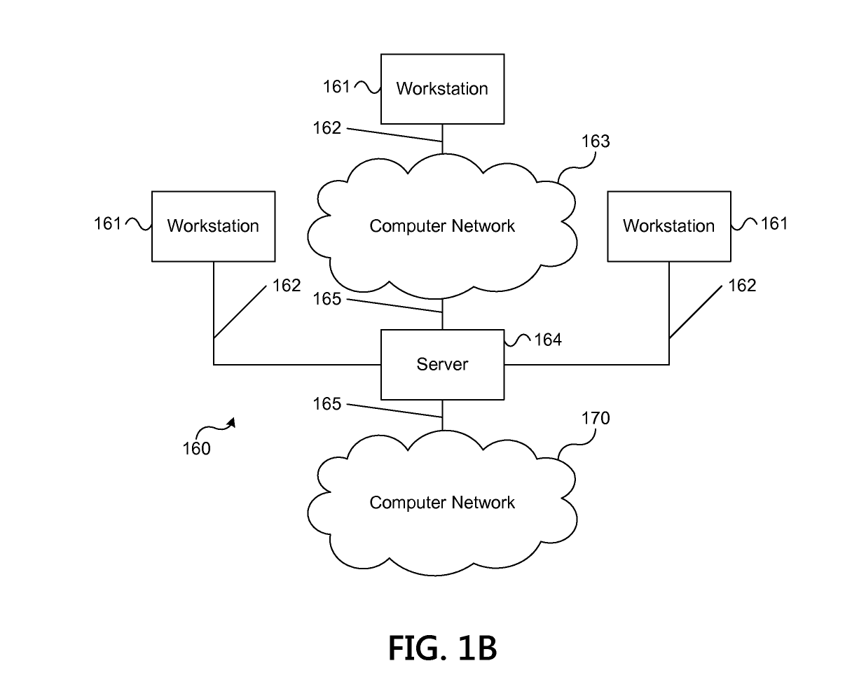

FIG. 2 illustrates an example of a system 200 for detecting and measuring malware threats according to one or more embodiments. In some embodiments, system 200 may be implemented in one or more computing devices, which may include and/or incorporate one or more processors, one or more memories, and/or one or more aspects of the computing device 101 discussed above. In some instances, system 200 may include a number of different subsystems, databases, and/or libraries. In some arrangements, all of the subsystems included in system 200 may be included in and/or incorporated into a single computing device, while in other arrangements, each subsystem included in system 200 (and/or combinations thereof) may be included in and/or incorporated into a distinct and/or dedicated computing device.

As seen in FIG. 2, in some embodiments, system 200 may include a data collection and aggregation subsystem 205, a heat map generation subsystem 210, and a dynamic response subsystem 215. This arrangement represents one example configuration of system 200. In other embodiments, one or more elements of system 200 may be combined and/or additional and/or alternative subsystems may be included in addition to and/or instead of those shown in FIG. 2.

In some embodiments, data collection and aggregation subsystem 205 may be configured to collect and aggregate information about various applications, websites, and/or other resources that may be provided by an organization, including information about the various malware threats that such applications, websites, and/or other resources have been and/or are being exposed to. In one or more arrangements, the information that is collected and/or aggregated by data collection and aggregation subsystem 205 may include information about the communications between one or more externally-facing web applications (which may, e.g., be monitored by system 200, provided to one or more users that are external to an organization implementing system 200, and referred to as “monitored applications”) and one or more client computing devices (which may, e.g., be used by the one or more users that are external to the organization), as this information may be indicative of how certain applications are being accessed and/or used by customer computing devices and, relatedly, what, if any, types of malware threats such applications are being exposed to as a result of such access and/or usage.

For example, data collection and aggregation subsystem 205 may receive information about one or more malware threats, including malware infections and/or attacks, that may have affected and/or may be affecting one or more applications and/or other computing resources being monitored by system 200. In some instances, data collection and aggregation subsystem 205 may receive such information from another system (e.g., a threat detection system that is distinct and/or separate from system 200) and/or another subsystem of system 200 (which may, e.g., be configured to detect such malware threats). In some arrangements, data collection and aggregation subsystem 205 may itself be configured to monitor various applications (and/or one or more computing systems and/or other resources that may provide such applications), interrogate one or more client computing devices (which may, e.g., connect to and/or exchange data with the one or more applications), and/or identify malware threats that may be affecting particular applications (which may, e.g., be originating from particular client computing devices).

The applications, websites, and/or other resources that are monitored by system 200 may, in some arrangements, include various externally-facing applications, websites, and/or other resources that are provided by an organization (e.g., the organization implementing and/or deploying system 200). In addition, such applications, websites, and/or other resources may be designed to be used by customers of the organization for various purposes. For example, the applications, websites, and/or other resources that are monitored by system 200 may include online portals for managing accounts (e.g., financial accounts), obtaining information about and/or purchasing new products, providing feedback about products and/or services, requesting assistance with various products and/or services, and/or performing other functions.

In some arrangements, data collection and aggregation subsystem 205 may be configured to monitor a number of different applications that may be provided by an organization and can be accessed by various users. In some instances, data collection and aggregation subsystem 205 may, in a particular browsing session in which a user is accessing a monitored application, conduct an inspection of the user's browser and/or of the user's account information in order to collect malware detection data for the monitored application. Additionally or alternatively, data collection and aggregation subsystem 205 may obtain access logs and/or other records that include information about other communications with the user's computing device. Such logs may, for example, indicate when particular communications happened, what applications particular communications were sent to and/or received from, the sizes of particular communications (e.g., in bits and/or bytes), the types of particular communications (e.g., whether particular communications were TCP/IP communications, UDP communications, and/or other types of communications), and/or other information about various communications. In addition to obtaining and/or otherwise collecting information about various applications, data collection and aggregation subsystem 205 may aggregate the collected information (e.g., by storing the collected information, indexing the collected information, and/or otherwise organizing the collected information).

In one or more embodiments, in collecting malware detection data, data collection and aggregation subsystem 205 may monitor various aspects of a client computing device and/or the client computing device's communications with one or more servers and/or other devices that may be configured to provide the one or more monitored applications. For example, in collecting the malware detection data, data collection and aggregation subsystem 205 may monitor one or more mouse clicks and/or keystrokes (which may, e.g., be representative of malware that is running on the client computing device interacting with the one or more monitored applications during a browsing session), the IP address of the client computing device and/or other device fingerprint information, such as MAC address, serial number, and/or other unique hardware and/or software identifiers (which may, e.g., enable data collection and aggregation subsystem 205 to track which of the one or more monitored applications the client computing device is interacting with and/or attempting to interact with), and/or failed log-in information (which may, e.g., be used by data collection and aggregation subsystem 205 in determining a risk score indicative of whether the client computing device is being legitimately used to access one or more user accounts associated with the one or more monitored applications and/or whether the client computing device is being maliciously used to access such account(s) without authorization).

Thus, the malware detection data that is collected and/or aggregated by data collection and aggregation subsystem 205 may, in some instances, include information about one or more of mouse movements and/or clicks (which may, e.g., be obtained by monitoring various mouse movements and/or clicks on the client computing device, including the speed of the mouse movements and/or mouse clicks on the client computing device), information about keystrokes (which may, e.g., be obtained by monitoring keystrokes on the client computing device, including the speed of the keystrokes), information about user Internet Protocol (IP) address (which may, e.g., be used in comparing the log-in IP address to the initial log-in IP address of the client computing device and/or comparing the IP address of the client computing device to database of previously identified IP addresses associated with bad actors), device fingerprint information (which may, e.g., be used in detecting if the client computing device used to log-in to the monitored application matches a previously verified device used for access to the monitored application), and/or failed log-in information (which may, e.g., indicate a number of unsuccessful log-in attempts for a particular client computing device in attempting to access one or more monitored applications).

In some embodiments, heat map generation subsystem 210 may be configured to generate a heat map based on the aggregation of the collected malware detection data (e.g., the malware detection data that may be collected and/or aggregated by data collection and aggregation subsystem 205). In one or more arrangements, the heat map generated by heat map generation subsystem 210 may be configured to identify one or more malware threats associated with one or more monitored applications. For example, the heat map may identify particular malware threats that have previously and/or are currently affecting one or more applications being monitored by system 200. As discussed above, such malware threats may include malware infections on client computing devices that are attacking and/or otherwise affecting the one or more monitored applications.

In some instances, in generating the heat map, the heat map generation subsystem 210 may measure malware variant (e.g., the type and/or version of the malware that is infecting the client computing device and/or attacking the one or more monitored applications), malware severity (e.g., the impact that the malware and/or particular types of malware are having on the one or more monitored applications and/or organizational resources, such as servers and/or other systems that may be configured to provide the one or more monitored applications), and/or malware volume (e.g., the amount of data that the malware and/or the infected client computing device(s) are exchanging with the one or more monitored applications and/or other organizational resources, such as servers and/or other systems that may be configured to provide the one or more monitored applications). In measuring any and/or all of these various metrics, heat map generation subsystem may obtain and/or analyze malware detection data and/or other information from data collection and aggregation subsystem 205.

In some instances, in generating the heat map, the heat map generation subsystem 210 may perform a trend analysis based on the aggregation of the collected malware data, and the heat map may be generated based on the trend analysis. For example, in generating the heat map, heat map generation subsystem 210 may identify one or more trends in the malware detection data (which, e.g., may be obtained from data collection and aggregation subsystem 205), such as trends in the types of malware detected on client computing device(s) and/or in the types of malware attacking the one or more monitored applications, trends in the frequency of malware attacks (e.g., with respect to particular type(s) of malware and/or overall with respect to all types of malware), and/or other trends. In addition to identifying the one or more trends, heat map generation subsystem 210 may insert information associated with the identified trends into the heat map, as such trend information may represent predictive data about future conditions for the state(s) of the one or more monitored applications.

For example, heat map generation subsystem 210 may perform a trend analysis (such as, e.g., regression analysis, histograms, correlation analysis, and the like) of the collected malware detection data. In some instances, the aggregated malware detection data may be obtained from a number of applications, such as externally facing applications, or, in other instances, may be obtained from a single session application. Heat map generation subsystem 210 may generate a heat map that is based on and/or incorporates the trend analysis of the aggregated malware detection data. In some instances, the heat map produced by the heat map generation subsystem 210 may identify one or more malware threats associated with the monitored applications. For example, the trend analysis may identify the increase and/or decrease in the identification of malware detection data by data collection and aggregation subsystem 205. In other instances, the trend analysis may identify and sort the collected malware detection data to determine if the malware detection data is localized to an individual application or content group/software asset.

In some instances, the heat map (which, e.g., may be generated by heat map generation subsystem 210) may identify and/or group the malware detection data by group, identification number, and/or identification name. In some instances, the heat map may identify and/or sort the malware detection data by malware variant, malware severity and/or malware volume. For example, the malware variant data may include malware family, subfamily, and severity/variant strain. Additionally, the malware volume data may include trending infection count by variant and/or by time. In some instances, the generated heat map may be used to identify where malware threats exist and how those identified threats are changing. In some situations, the higher the number of malware threats or incidents identified in the heat map, the hotter the number may be.

In some embodiments, dynamic response subsystem 215 may be configured to cause at least one dynamic response to be provided to a particular malware threat based on the heat map (which, e.g., may be generated by heat map generation subsystem 210). For example, with respect to a particular browsing session in which a particular client computing device and/or a particular user thereof is interacting with a monitored application, dynamic response subsystem 215 may selectively increase or decrease an amount of friction encountered by the client computing device and/or the user during the browsing session based on information included in the heat map. For instance, if dynamic response subsystem 215 detects that the client computing device is infected with a particular type of malware (e.g., based on device fingerprint information, based on interrogating the browser being used on the client computing device by the user, based on other information received from the client computing device, and/or the like), dynamic response subsystem 215 may increase friction during the browsing session by crippling the monitored application. In crippling the monitored application, dynamic response subsystem 215 may, for instance, selectively disable one or more functions that might otherwise be available (e.g., to other devices and/or users that are not infected with the malware and/or that otherwise have lower risk levels and/or risk scores). Additionally or alternatively, causing a dynamic response to be provided may include increasing the amount of friction by adding and/or otherwise imposing at least one of challenge-response tests, (e.g., scrambled word recognition tests, security questions, and the like), IP address verification processes, and/or other security measures. In certain situations, where heat map generation subsystem 210 has recognized a lack of malware infection threat(s) (e.g., with respect to a particular browsing session involving a particular client computing device), dynamic response subsystem 215 may be configured to reduce or minimize the amount of friction experienced by a user (e.g., a user of the particular client computing device during the particular browsing session) when accessing an application.

In some arrangements, dynamic response subsystem 215 may be configured to generate an alert and/or notification in response to a malware infection threat and/or malware infection incident (e.g., based on a determination by heat map generation subsystem 210). In certain instances, the alert may identify the location of the malware threat or infection and/or provide one or more details regarding the malware threat or infection (e.g., the malware variant, the malware volume, the malware severity, and the like). In certain instances, dynamic response subsystem 215 may be configured to transmit the generated alert to an application team (e.g., the application owner, support team, one or more executives, and/or other individuals). In some instances, dynamic response subsystem 215 may transmit the generated alert directly to the user of the monitored application.

In some arrangements, dynamic response subsystem 215 may receive an indication and/or notification of one or more malware infection threats and/or incidents (e.g., from heat map generation subsystem 210). In some instances, dynamic response subsystem 215 may receive the notification of one or more malware infection threats and/or incidents while the application is active (e.g., being accessed by a user). In other instances, dynamic response subsystem 215 may receive the notification of one or more malware infection threats and/or incidents after the application is closed (e.g., after a user's browser session has ended). In some instances, dynamic response subsystem 215 may be configured to provide a dynamic response to the application while it is active (e.g., by feeding the dynamic response into the application in real time). In such instances, the dynamic response may disrupt the malware infection threat and/or incident (e.g., by disrupting, interrupting or shifting the malware infection attack). Additionally or alternatively, dynamic response subsystem 215 may be configured to monitor, collect and log informational data from the application after indication of a malware infection threat and/or incident. Collected informational data from the malware infection and/or threat may be fed back into the heat map and may, for example, be used by heat map generation subsystem 210 to dynamically modify the heat map.

As indicated above, these are examples of the subsystems and/or other elements that may be included in system 200 in some embodiments, as well as some of the functions that may be performed (e.g., by system 200 and its various subsystems). In other embodiments, additional and/or alternative subsystems and/or other elements may similarly be included and/or other functions may be performed, in addition to and/or instead of those discussed above.

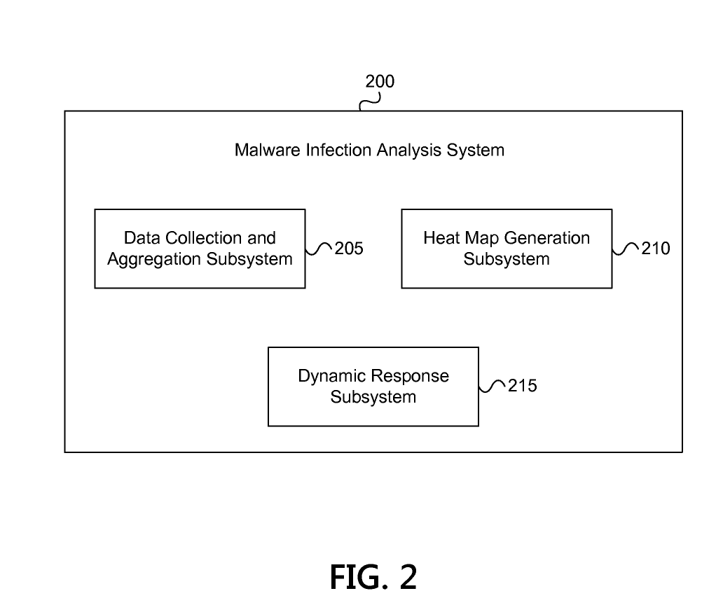

Having described an example system that may be used in detecting and measuring malware threats in some embodiments, an example of a method that may, in some embodiments, be performed (e.g., by such a system 200; by another computing device, such as computing device 101; and/or the like) will now be discussed in greater detail with respect to FIG. 3.

FIG. 3 illustrates a flowchart that depicts a method of detecting and measuring malware threats according to one or more embodiments. In some embodiments, the example method illustrated in FIG. 3 may be performed by a computing device, which may include and/or implement one or more aspects of computing device 101. In additional and/or alternative embodiments, the example method illustrated in FIG. 3 may be performed by a computer system, such as system 200. In other embodiments, the example method illustrated in FIG. 3 may be implemented in and/or may otherwise be embodied in computer-readable instructions that may be stored in a computer-readable medium, such as a memory.

As seen in FIG. 3, the method may be initiated in step 305, in which malware detection data may be collected. For example, in step 305, a computing device (e.g., computing device 101, system 200, and/or the like) may collect malware detection data from one or more monitored applications. The malware detection data that is collected in step 305 may, for instance, include information about various applications, websites, and/or other resources that may be provided by an organization, including information about the various malware threats that such applications, websites, and/or other resources have been and/or are being exposed to, as discussed above. For instance, in collecting malware detection data from the one or more monitored applications in step 305, the computing device may collect information about the communications between one or more externally-facing web applications (which may, e.g., be monitored by the computing device and/or provided to one or more customers and/or other external users) and one or more client computing devices, as this information may be indicative of how certain applications are being accessed and/or used by customer computing devices and, relatedly, what, if any, types of malware threats such applications are being exposed to.

In some instances, in collecting malware detection data in step 305, the computing device may monitor various aspects of a client computing device and/or the client computing device's communications with one or more servers and/or other devices that may be configured to provide the one or more monitored applications. For example, in collecting the malware detection data, the computing device may monitor one or more mouse clicks, mouse movement information, and/or keystrokes (which may, e.g., be representative of malware on the client computing device interacting with the one or more monitored applications), the IP address of the client computing device and/or other device fingerprint information, such as MAC address, serial number, and/or other unique hardware and/or software identifiers (which may, e.g., enable the computing device to track which of the one or more monitored applications the client computing device is interacting with and/or attempting to interact with), and/or failed log-in information (which may, e.g., enable the computing device to establish a risk score indicative of whether the client computing device is being legitimately used to access one or more user accounts associated with the one or more monitored applications and/or whether the client computing device is being maliciously used to access such account(s) without authorization).

In step 310, the collected malware detection data may be aggregated. For example, in step 310, the computing device may aggregate the malware detection data that was collected in step 305. In aggregating the malware detection data in step 310, the computing device may, for instance, store the collected malware detection data, index the collected malware detection data (e.g., based on one or more index keys, such as malware type, malware variant, malware severity, and/or the like), and/or otherwise organize the collected malware detection data.

In step 315, a heat map may be generated. For example, in step 315, the computing device may generate a heat map based on the collected and/or aggregated malware detection data that identifies (and/or is configured to identify) one or more malware threats associated with one or more monitored applications. For instance, the heat map generated in step 315 may identify particular malware threats that have previously and/or are currently affecting one or more applications being monitored by the computing device. As discussed above, such malware threats may include malware infections on client computing devices that are attacking and/or otherwise affecting the one or more monitored applications. In some instances, the factors and/or other information that may be taken into account in generating the heat map may, for example, include: whether monitored mouse movements and/or mouse clicks are faster than a human user could perform; whether monitored keystrokes are made at a speed that is beyond what a human user could perform; whether a user's IP address has been used in an attack and/or otherwise involved in a malware infection incident before; what country the user's IP address is located in; whether the device fingerprint for the device used to access the application matches the device fingerprint of the device used to access the application for the first time; and/or whether there have been any unsuccessful log-in attempts of the application. While these are examples of some of the factors and/or other information that may be taken into account in generating the heat map in some arrangements, in other arrangements, additional and/or alternative types of data may similarly be accounted for in generating the heat map in addition to and/or instead of those discussed here.

In some arrangements, in generating the heat map in step 315, the computing device may calculate one or more risk scores for each of the malware threats identified in the collected and/or aggregated malware detection data. In some instances, the risk scores may indicative of the overall risk posed by particular malware to a particular monitored application. Additionally or alternatively, a number of risk scores may be calculated for each type of malware that may be affecting each of the monitored applications, in which case each risk score may be indicative of the impact and/or severity of the particular type of malware on the particular monitored application. For example, for a particular type of malware that may be affecting a particular monitored application, the computing device may determine a risk score based on the number of communications received by the application from the malware, the number of client computing devices infected by the malware, the number of seconds that the monitored application has been slowed and/or otherwise affected by the malware, and/or other factors. Such a risk score may, for instance, be calculated by adding, multiplying, and/or otherwise combining these numerical factors to obtain a numerical risk score.

In some embodiments, in generating the heat map in step 315, the computing device may measure malware variant (e.g., the type and/or version of the malware that is infecting the client computing device and/or attacking the one or more monitored applications), malware severity (e.g., the impact that the malware and/or particular types of malware are having on the one or more monitored applications and/or organizational resources, such as servers and/or other systems that may be configured to provide the one or more monitored applications), and/or malware volume (e.g., the amount of data that the malware and/or the infected client computing device(s) are exchanging with the one or more monitored applications and/or other organizational resources, such as servers and/or other systems that may be configured to provide the one or more monitored applications). In measuring any and/or all of these various metrics, the computing device may analyze and/or otherwise utilize the collected and/or aggregated malware detection data.

In some embodiments, in generating the heat map in step 315, the computing device may perform a trend analysis based on the aggregation of the collected malware data, and the heat map may be generated based on the trend analysis. For example, in generating the heat map in step 315, the computing device may identify one or more trends in the collected and/or aggregated malware detection data, such as trends in the types of malware detected on client computing device(s) and/or attacking the one or more monitored applications, trends in the frequency of malware attacks (e.g., with respect to particular type(s) of malware and/or overall with respect to all types of malware), and/or other trends. In addition to identifying the one or more trends, the computing device may insert information associated with the identified trends into the heat map, as such trend information may represent predictive data about future conditions for the state(s) of the one or more monitored applications. For example, the trend analysis and/or the trend information inserted into the heat map may indicate an increase or decrease in the identification of and/or effect of particular type(s) of malware on particular applications. In other instances, the trend analysis and/or the trend information inserted into the heat map may indicate that particular type(s) of malware are having a localized impact on an individual application.

In step 320, one or more dynamic responses may be provided and/or may be caused to be provided based on the generated heat map. For example, in step 320, the computing device may cause one or more dynamic responses to be provided to a particular malware threat based on the generated heat map. For example, with respect to a particular browsing session in which a particular client computing device and/or a particular user thereof is interacting with a monitored application, the computing device may selectively increase or decrease an amount of friction encountered by the client computing device and/or the user during the browsing session based on information included in the heat map. For instance, if the computing device determines that the client computing device is infected with a particular type of malware (e.g., based on the collected and/or aggregated malware detection data, based on device fingerprint information, based on interrogating the browser being used on the client computing device by the user, based on other information received from the client computing device, and/or the like), the computing device may increase friction during the browsing session by crippling the monitored application. In crippling the monitored application, the computing device may, for instance, selectively disable (e.g., on the server side and/or on the client side) one or more functions that might otherwise be available (e.g., to other devices and/or users that are not infected with the malware and/or that otherwise have lower risk levels and/or risk scores). Additionally or alternatively, causing a dynamic response to be provided may include increasing the amount of friction by adding and/or otherwise imposing at least one of challenge-response tests, (e.g., scrambled word recognition tests, security questions, and the like), IP address verification processes, and/or other security measures. In certain situations, where the computing device has recognized a lack of malware infection threat(s) (e.g., with respect to a particular browsing session involving a particular client computing device), the computing device may be configured to reduce or minimize the amount of friction experienced by a user (e.g., a user of the particular client computing device during the particular browsing session) when accessing an application.

Additionally or alternatively, in causing a dynamic response to be provided in step 320, the computing device may look up and/or otherwise obtain information about the internal owner (e.g., within the organization) of a monitored application that is being affected by a malware threat, and subsequently may execute a number of steps to notify the owner about the malware threat. For example, after looking up and/or otherwise obtaining such owner information, the computing device may generate a notification and/or alert based on the owner information and the nature of the malware threat, and subsequently send the notification and/or alert to the application owner. In some embodiments, causing a dynamic response to be provided also may include periodically reevaluating the affected monitored application and/or the malware threat and, if appropriate, sending one or more follow-up notifications and/or alerts.

Subsequently, the method may end. As illustrated in the examples above, however, certain aspects of the malware detection data collection and aggregation, as well as the heat map generation and/or dynamic response functionalities, may be repeated (e.g., in evaluating new malware threats, in reevaluating a previously identified malware threat, and/or the like). Additionally or alternatively, the computing device may perform similar steps as those illustrated in FIG. 3 and discussed above in detecting and measuring other malware threats.

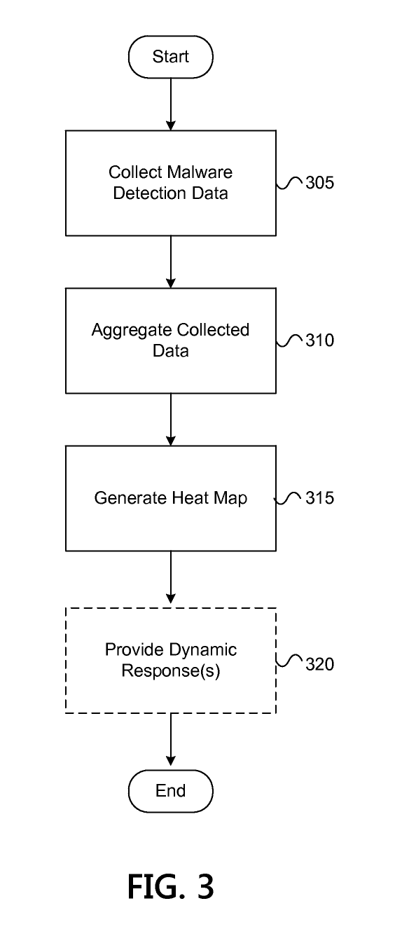

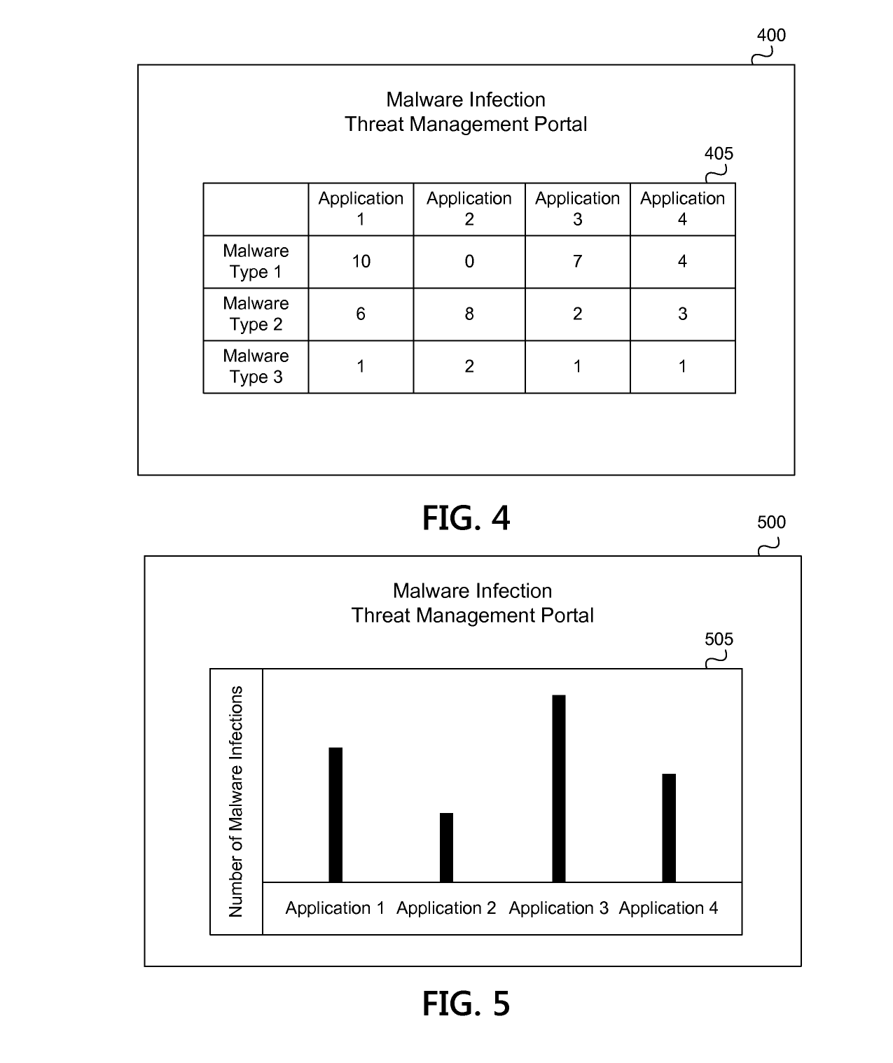

Having described several examples of the processing that may be performed by a computing device in detecting and measuring malware threats in some embodiments, several example user interfaces, including examples of heat maps and/or heat map information, that might be displayed and/or otherwise provided by a computing device, such as computing device 101 and/or system 200, in performing such processing and/or in otherwise detecting and measuring malware threats and will now be discussed with respect to FIGS. 4 and 5.

FIG. 4 illustrates an example of a user interface that may be displayed in providing status information about malware threats in one or more embodiments. As seen in FIG. 4, in some instances, a computing device implementing one or more aspects of the disclosure (e.g., computing device 101, system 200, and/or the like) may display and/or otherwise provide a user interface 400 that includes a portal in which information about various malware threats can be displayed.

In some arrangements, user interface 400 may include a table 405 that may represent and/or include a heat map that is configured to identify one or more malware threats associated with one or more monitored applications (e.g., similar to the heat maps that may be generated by the systems and methods discussed above). In particular, table 405 may include information about a number of different malware threats (e.g., as labeled in the left-hand column), as well as the overall risk and/or impact of each of the different malware threats on various monitored applications (e.g., as labeled in the top row). In some instances, the value in each of the cells in table 405 may, for example, correspond to and/or represent a risk score for the particular malware threat with respect to the particular monitored application.

FIG. 5 illustrates another example of a user interface that may be displayed in providing status information about malware threats in one or more embodiments. As seen in FIG. 5, in some instances a computing device implementing one or more aspects of the disclosure (e.g., computing device 101, system 200 and/or the like) may display and/or otherwise provide a user interface 500 that includes a portal in which information about various malware threats can be displayed.

In some arrangements, user interface 500 may include a graph 505 in which a number of malware threats are displayed for different monitored applications. For example, for each monitored application, graph 505 may include the number of malware threats affecting the particular application during a predetermined time period. Additionally or alternatively, graph 505 may include representation of the different malware families, subfamilies, and the like, that trigger a malware infection threat and/or incident for each application. In one or more arrangements, graph 505 may be included in and/or considered part of the heat map (which may, e.g., be generated by the systems and methods discussed above).

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perforin such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in teems of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A method, comprising:
collecting, by a computing device, malware detection data from one or more monitored applications;
aggregating, by the computing device, the collected malware detection data; and
generating, by the computing device, based on the aggregation of the collected malware detection data, a heat map, wherein the heat map is configured to identify one or more malware threats associated with one or more monitored applications.

2. The method of claim 1, wherein collecting the malware detection data includes monitoring one or more of mouse clicks, keystrokes, IP address, device fingerprint, failed log-in information.

3. The method of claim 1, wherein generating the heat map includes measuring malware variant, malware severity, malware volume.

4. The method of claim 1,
wherein generating the heat map includes: performing a trend analysis based on the aggregation of the collected malware detection data, and
wherein the heat map is generated based on the trend analysis.

5. The method of claim 1, further comprising:
causing at least one dynamic response to be provided based on the generated heat map.

6. The method of claim 5, wherein causing the at least one dynamic response to be provided includes reducing friction for a user based on the collected malware detection data.

7. The method of claim 5, wherein causing the at least one dynamic response to be provided includes increasing friction for a user based on the collected malware detection data.

8. A computing device, comprising:
at least one processor; and
memory storing computer readable instructions that, when executed by the at least one processor, cause the computing device to:
collect malware detection data from one or more monitored applications;
aggregate the collected malware detection data; and
generate, based on the aggregation of the collected malware detection data, a heat map, wherein the heat map is configured to identify one or more malware threats associated with one or more monitored applications.

9. The computing device of claim 8, wherein collecting the malware detection data includes monitoring one or more of mouse clicks, keystrokes, IP address, device fingerprint, failed log-in information.

10. The computing device of claim 8, wherein generating the heat map includes measuring malware variant, malware severity, malware volume.

11. The computing device of claim 8,
wherein generating the heat map includes: performing a trend analysis based on the aggregation of the collected malware detection data, and
wherein the heat map is generated based on the trend analysis.

12. The computing device of claim 8, wherein the memory stores additional computer readable instructions that, when executed by the at least one processor, further cause the computing device to:
cause at least one dynamic response to be provided based on the generated heat map.

13. The computing device of claim 12, wherein causing the at least one dynamic response to be provided includes reducing friction for a user based on the collected malware detection data.

14. The computing device of claim 12, wherein causing the at least one dynamic response to be provided includes increasing friction for a user based on the collected malware detection data.

15. One or more non-transitory computer-readable media having computer-executable instructions stored thereon that, when executed by a computing device, cause the computing device to:
collect malware detection data from one or more monitored applications;
aggregate the collected malware detection data; and
generate, based on the aggregation of the collected malware detection data, a heat map, wherein the heat map is configured to identify one or more malware threats associated with one or more monitored applications.

16. The one or more non-transitory computer-readable media of claim 15, wherein collecting the malware detection data includes monitoring one or more of mouse clicks, keystrokes, IP address, device fingerprint, failed log-in information.

17. The one or more non-transitory computer-readable media of claim 15, wherein generating the heat map includes measuring malware variant, malware severity, malware volume.

18. The one or more non-transitory computer-readable media of claim 15,
wherein generating the heat map includes: performing a trend analysis based on the aggregation of the collected malware detection data, and
wherein the heat map is generated based on the trend analysis.

19. The one or more non-transitory computer-readable media of claim 15, having additional computer-executable instructions stored thereon that, when executed by the computing device, further cause the computing device to:
cause at least one dynamic response to be provided based on the generated heat map.

20. The one or more non-transitory computer-readable media of claim 19, wherein causing the at least one dynamic response to be provided includes increasing friction for a user based on the collected malware detection data.
